(19) United States
(12) Patent Application Publication
(10) Pub. No.: US 2011/0264278 A1
(43) Pub. Date: Oct. 27, 2011

(54) PROPERTY MANAGEMENT SYSTEM AND METHOD OF OPERATION

(75) Inventors: John J. Gilbert, New Rochelle, NY (US); Eugene M. Boniberger, West Islip, NY (US)

(73) Assignee: RUDIN MANAGEMENT CO. INC., New York, NY (US)

(21) Appl. No.: 12/909,012

(22) Filed: Oct. 21, 2010

Related U.S. Application Data
(60) Provisional application No. 61/256,679, filed on Oct. 30, 2009.

(51) Int. Cl. G06F 1/28; G05D 23/19

(52) U.S. Cl. 700/277; 700/275

(57) ABSTRACT

A property management system is provided. The property management system includes a property management console that is coupled to a plurality of building subsystems. The property management console aggregates data from the building subsystems, historical databases, and external sources such as weather predications. From the aggregated data, property management console displays information for a building manager indicating the current energy consumption and expected energy consumption. The property management console further allows the building manager the ability to drill down into the data by selecting one of the aggregated indicators.

### BACKGROUND OF THE INVENTION

The subject matter disclosed herein relates to a system for assisting property managers in monitoring building subsystems, and in particular to a system that allows a building operator to quickly assess the operational status and energy usage of the buildings they manage.

Commercial buildings often have a variety of subsystems that assist the building operator or manager in maintaining the proper functioning of their building. These subsystems may include heating, ventilation, and air conditioning (HVAC), fire alarm and communications, security, and elevator management systems for example. Typically, the supplier of the subsystem provides the operator with some type of control interface that allows the building manager to interact with the subsystem, control aspects of its operation and assess its status. In some cases the interface may be a simple control panel having a set of indicators that is arranged in a utility closet for example. In other cases, the interface may be a dedicated console or software run on a general purpose computer. In any event, these control systems require the building manager to actively seek out the information and check each subsystem individually. Further, they also do not easily allow the building manager to share the information with their tenants.

One of the larger expenses in the operation of a commercial building for the building owner or manager is the heating and air conditioning of the space. In a typical high rise type commercial building, it may cost the building owner or manager $500-$1000 per hour to operate a facility of 700,000 square feet during the business day. To minimize these costs, building managers typically adjust the temperature of the building during non-business hours, such as by decreasing the building temperature during the winter and increasing the building temperature during the summer. Since tenants desire their office space to be at a comfortable temperature, the building manager will perform a pre-start procedure each day to adjust the building temperature to the desired temperature at the beginning of the work day. The length of time required for the pre-start to be effective will depend on a number of factors, including the weather, relative humidity, the season, and level of occupancy for example. Usually, the building manager uses the warmest or coolest position in the building as a measure for determining the pre-start time required. Due to the number of factors involved, this process is usually left to the building managers judgment based on their historical knowledge and experience with their building and how it reacts.

Over time energy consumption has increased and in some cases surpassed the ability of the infrastructure to deliver adequate resources. In an attempt to address these issues, various government bodies have proposed or implemented regulations affecting building owners/managers. In general, these regulatory schemes have aimed to address excess demand during peak consumption periods. In some cases these regulations have required building owners and managers to be responsible for measuring and managing the energy consumption patterns of the buildings commercial, retail and residential customers. It should be appreciated that the discrete nature of the building subsystem controls makes it difficult for the building manager to ascertain the current operational state of the building and make real-time adjustments to curtail energy usage.

Accordingly, while existing building management systems are adequate for their intended purposes, there remains a need for improvements particularly in the integration and dissemination of building information systems.

### BRIEF DESCRIPTION OF THE INVENTION

According to one aspect of the invention, a property management system is provided. The property management system includes a plurality of building subsystems, each of the plurality of building subsystems having an associated control. At least one database having historical data for a building. A display and a controller operably coupled to the plurality of building subsystems, the at least one database and the display. The controller having a processor responsive to executable computer instructions when executed on the processor for displaying a first graphical representation on the display indicating a consumption level of energy and for displaying a second graphical representation on the display indicating a status of one of the plurality of building subsystems.

According to another aspect of the invention, a property management system is provided having a master property management controller. The master property management controller includes an input for receiving a first signal from a plurality of first property management controllers. Each of the first property management controllers associated with one of a plurality of buildings. A display is coupled to the master property management controller. Wherein the master property management controller includes a processor responsive to executable computer instructions when executed on the processor for displaying a first graphical representation on the display indicating an aggregate consumption level of energy for the plurality of buildings in response to the first signal.

According to another aspect of the invention, a method of pre-starting a building heating, ventilation and air conditioning system is provided. The method includes storing building performance data in a database, the building performance data including weather data, pre-start initiation time, and pre-start finish time. A weather forecast data is received. The building performance data is correlated with the weather forecast data. A time for the pre-starting the building heating, ventilation and air conditioning system from the correlated data is determined. The pre-start of the building heating, ventilation and air conditioning system is initiated at the time.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a property management system in accordance with one embodiment of the invention;

FIG. 2 is a schematic diagram of a building incorporating the property management system of FIG. 1;

FIG. 3 is an illustration of a property management console for the property management system of FIG. 1;

FIG. 4 is a schematic diagram of a property management system for managing multiple properties; and,

FIG. 5 is a flow diagram of a method for determining the pre-start time required to adjust a building temperature.

The detailed description explains embodiments of the invention, together with advantages and features, by way of example with reference to the drawings.

### DETAILED DESCRIPTION OF THE INVENTION

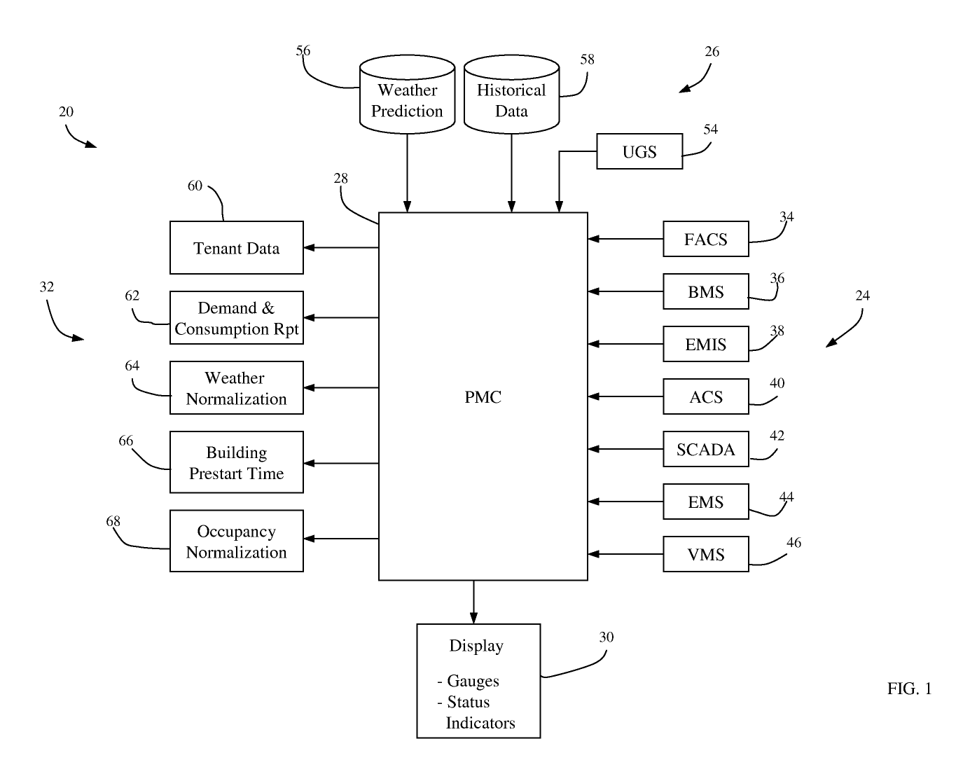

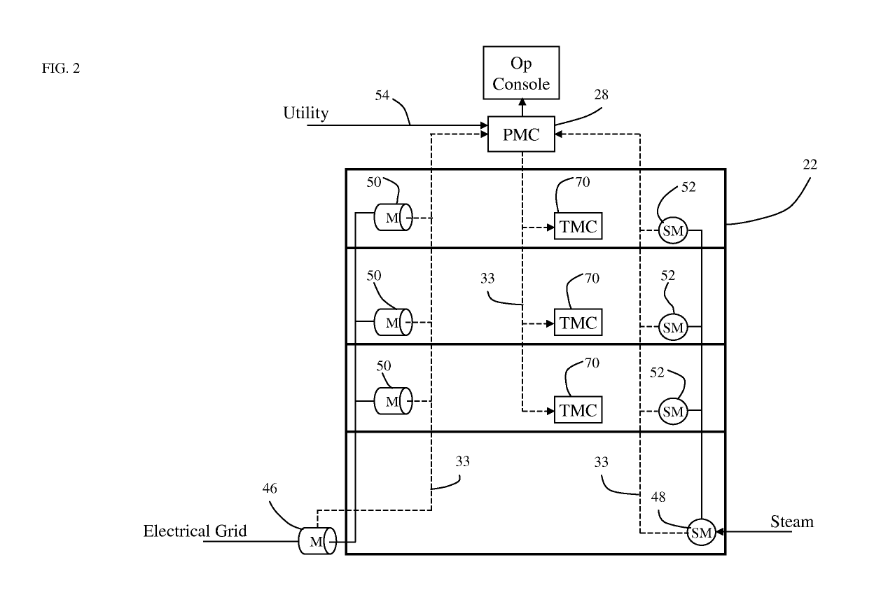

FIG. 1 and FIG. 2 illustrate an exemplary property management system 20 for a building 22. The property management system 20 is used by the building owner or building manager to access the real-time operational status of the building 22 and its various subsystems. The property management system 20 includes a property management console 28 that receives subsystem inputs 24 from building subsystems and also external inputs 26. In response to these inputs 24, 26, the property management console 28 provides a number of outputs, including a display 30 and operational outputs 32. It should be appreciated that as used herein, the term building manager or building owner may be used interchangeably to denote the person or entity responsible for the operation of the building.

The various aspects of the property management system 20 transmit and receive signals over a communication medium 33. The communication medium 33 may be any known communication medium, including but not limited to a wide area network (WAN), a public switched telephone network (PSTN) a local area network (LAN), a global network (e.g. Internet), a virtual private network (VPN), and an intranet. The communication medium 33 may be implemented using a wireless network or any kind of physical network implementation known in the art. Aspects of property management system 20 may be coupled to the property management console 28 through multiple networks (e.g., intranet and Internet) so that not all portions of the management system are coupled through the same network. Furthermore, the some portions of property management system 20 may be connected to the property management console 28 by a combination of a PSTN and the Internet, for example. One or more portions of property management system 20 may be connected to the communication medium 33 in a wireless fashion.

The property management system 20 may also include one or more processing systems, such as property management console 28, tenant management console 70 and the controls for each of the building subsystems described herein. These processing systems 28, 70 may have one or more central processing units (processors). The processors are coupled to system memory and various other components via a system bus. Read only memory (ROM) is coupled to the system bus and may include a basic input/output system (BIOS), which controls certain basic functions of property management system 20. The processing systems may further include an input/output (I/O) adapter and a network adapter coupled to the system bus. I/O adapter may be a small computer system interface (SCSI) adapter that communicates with a hard disk and/or tape storage drive or any other similar component. A network adapter interconnects the system bus with communication medium 33 enabling processing systems to communicate with other such processing systems, such as between property management console 28 and building management system 36. One or more screens (e.g., a display monitor) are connected to the system bus by a display adaptor. Additional input/output devices may be connected to the system bus via user interface adapter and a display adapter. A keyboard, mouse, and speaker are all interconnected to the bus.

It will be appreciated that the property management console 28 can be any suitable computer or computing platform, and may include a terminal, wireless device, information appliance, device, workstation, mini-computer, mainframe computer, personal digital assistant (PDA) or other computing device. It shall be understood that the property management console 28 may include multiple computing devices or controllers linked together by a communication network. For example, there may exist a client-server relationship between two systems and processing may be split between the two.

The property management console 28 receives a variety of subsystem inputs 24. As will be discussed in more detail below, these subsystem inputs 24 may be aggregated and correlated with historical data to provide the building manager with a status for the building with respect to an expected performance. The subsystem inputs 24 include, but are not limited to, a fire alarm and communications system (FACS) 34, a building management system (BMS) 36, an elevator management and information system (EMIS) 38, an access control system (ACS) 40, a supervisory control and data acquisition system (SCADA) 42, an energy management system (EMS) 44, and a visitor management system (VMS) 46. As used herein, the BMS 36 refers to a system that allows the building manager to adjust the heating, ventilation and air conditioning (HVAC) settings within the building 22. The HVAC set points may be automatically adjusted by the BMS 36 or controlled manually by the building manager.

The EMS 44 aggregates energy consumption data from a variety of sensors 46, 48, 50, 52 within the building 22. These sensors include but are not limited to thermostats, temperature sensors, a building electrical meter 46, a building steam meter 48, a tenant electrical submeter 50 and a tenant steam submeter 52 for example. In the exemplary embodiment, the building 22 is coupled to a district heating system that provides steam to the building 22 for heating purposes. However, the EMS 44 may also be coupled with other types of energy consuming services, such as where the building 22 is heated by a petrochemical, such as oil or natural gas for example. Where the oil or natural gas is used as a fuel, an appropriate meter would be coupled to measure the amount of fuel being consumed.

The property management console 28 also receives a variety of external inputs 26. These external inputs include a utility grid status (UGS) 54, weather prediction data 56 and historical data 58. The UGS 54 is a real time status indicator that the property management console 28 receives from the electrical power supplier, such as the electrical utility. The UGS 54 provides an advanced warning to the building operator of the operational status or health of the electrical grid. Through the UGS 54, the utility can signal to the building manager potential issues that may impact the operations of building 22. In response to the UGS 54 signal, the building manager may institute actions in advance of a loss of power for example.

As mentioned above, the weather is a major factor in the operation of the HVAC systems in a building. The weather prediction data 56 includes a forecast of expected weather in the area of the building 22 for a desired time period, such as the following day for example. The weather prediction data 56 may be used by the property management console 28 as one variable to determine the pre-start time for initiating the HVAC system of building 22 for example. Weather prediction data 56 may also include a longer range forecast, such as a week or month for example, to allow the property management console 28 to forecast expected energy consumption. In this manner, the building manager can determine if adequate fuel is on site.

In the exemplary embodiment, the historical data 58 is a database that stores information collected by the property management console 28. The historical data 58 allows the property management console 28 to provide a comparison of the current real-time operating parameters with past operating conditions from similar circumstances. In one embodiment, the historical data 58 includes demand profile curve data for building energy usage and building performance data. The building performance data includes at least actual weather data (temperature, cloud cover, relative humidity), pre-start initiation time, pre-start finish time, energy usage and building temperatures. It should be appreciated that the historical data 58 may be physically stored in multiple databases as is known in the art. Further, in one embodiment, the historical data 58 includes manufacturer data for the subsystems within the building 22.

The property management console 28 also includes a number of operational outputs 32. These operational outputs include, but are not limited to, tenant data 60, usage reports 62, weather normalization 64, building pre-start time 66, and occupancy normalization 68. Building personnel in assessing the operation of the building 22 may use some of these operational outputs 32, such as usage reports 62 for example. The usage reports 62 may generate graphic and text reports on request for demand and consumption history and comparison of those values across different time periods. Usage reports 62 may also provide tabular or graphical representations of other operations data for the building 22. Other outputs, such as weather normalization 64 for example, are used to adjust alarms and set point parameters in the buildings subsystems.

In one embodiment, each tenant within the building 22 has a tenant management console 70 (FIG. 2). The tenant management console 70 provides the tenant with data relevant to their operation. The tenant management console 70 receives tenant data 60 from the property management console 28. The tenant data 60 is a subset of the overall data received by the property management console 28. The tenant data may also be data that is converted into a form more relevant to the tenant, such as energy consumption in dollars per hour instead of BTU per hour for example. In one embodiment, the property management console includes appropriate controls and security to prevent tenant data 60 from being transmitted to the wrong entity.

It will be appreciated that the tenant management console 70 can be any suitable computer, controller or computing platform, and may include a terminal, wireless device, information appliance, device, workstation, mini-computer, mainframe computer, personal digital assistant (PDA) or other computing device. It shall be understood that the tenant management console 70 may include multiple computing devices or controllers linked together by a communication network. For example, there may exist a client-server relationship between two systems and processing may be split between the two.

Other operational outputs 32 may be used as an input to one or more building 22 subsystems. The weather normalization 64 integrates weather data (real-time and predicted) to adjust alarm or set point parameters. The building pre-start time 66 uses weather prediction data 56 (temperature, RH, cloud cover) and historical performance data 58 under similar conditions, the system will predict a recommended building systems pre-start time (e.g. the time of day to start warming or cooling the building 22) in order to reach a desired indoor environment level by a predetermined point in time while minimizing operating time. Similarly, occupancy normalization 68 allows the property management console to integrate the current occupancy levels (based on vacant space) to adjust alarm parameters.

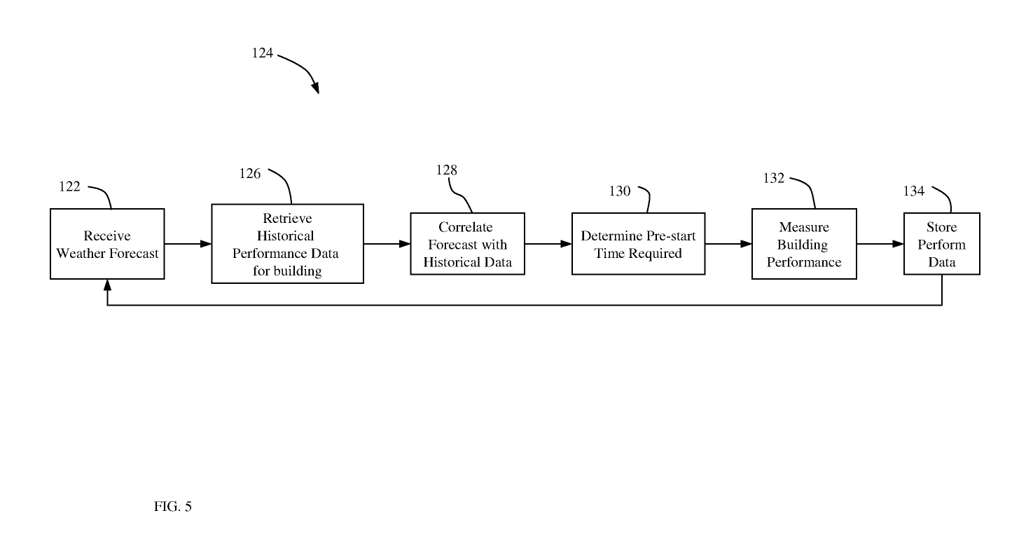

An exemplary embodiment of a method 124 of using an operational output 32 being used as an input to a building 22 subsystem is shown in FIG. 5. In this embodiment, the property management console 28 receives weather prediction data 56 in block 122. The method 124 then proceeds to retrieve historical data for the building 22 in block 126. The method 124 then correlates the forecast with the historical data in block 128 and determines in block 130 what pre-start time should be required to have the building 22 at the desired operating temperature. Any known prediction algorithm may determine the determination of the pre-start time. These prediction algorithms include but not limited to, regression techniques, discrete choice models, multivariate adaptive regression, and machine learning techniques. The method 124 then proceeds to block 132 where the performance of the building is measured. The measurements from block 132 are stored in the historical data database 58 in block 134 so that the accuracy of the predicted pre-start time may be further improved over time.

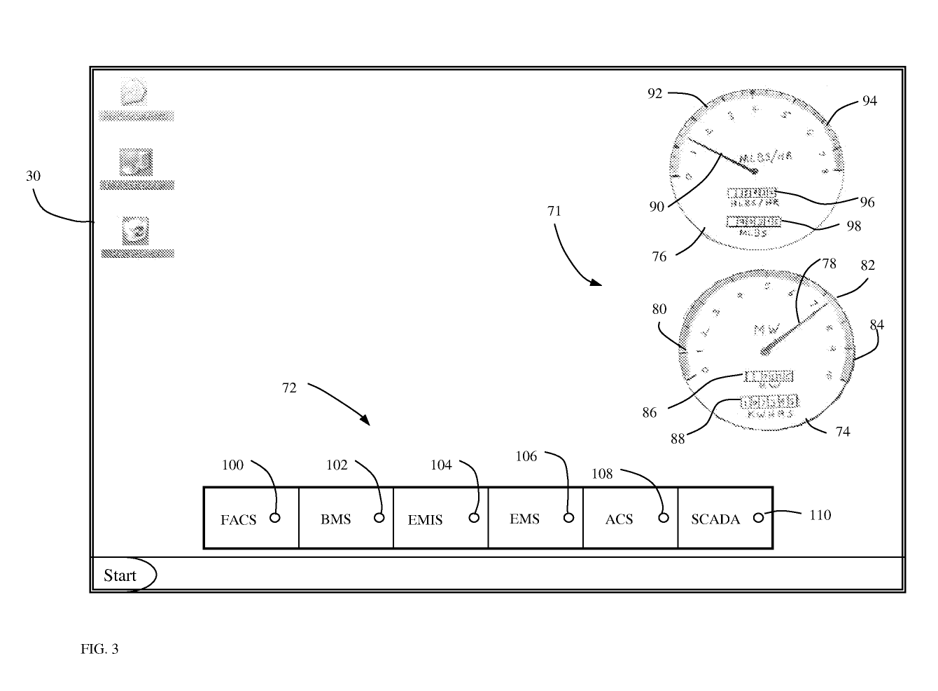

The property management console 28 also has a display 30 that provides a real time status indication to the building manager. One embodiment of display 30 is illustrated in FIG. 3. In this embodiment, the display 30 includes a gauges portion 71 and an indicator portion 72. In one embodiment, the display 30 is an output of the EMS 44, to highlight data collected from field devices (i.e. sub-metering building and tenant systems). In this embodiment, the display 30 is present as the desktop background of the building managers general-purpose computer monitor. The display 30 is visible to the building manager regardless of the current program in use. This provides advantages over previous subsystem controls that required the building manager to actively seek out information by going to specific locations to find data.

The gauges portion 71 is a graphical representation of an analog gauge such that the building manager can ascertain the status of the parameter being measured at a glance without having to specifically focus on the gauge. In the exemplary embodiment, the gauges portion 71 includes a first gauge 74 and a second gauge 76. The first gauge 74 outputs real time electrical demand and consumption information for the building 22. The first gauge 74 includes a needle indicator 78 that is rotated to point at the current level of electrical demand. The first gauge further includes operating ranges 80, 82, 84. The operating ranges 80, 82, 84 may be color coded to define a normal operating range 80 and a high consumption operating range 82. For example, normal operating range 80 may be colored green to indicate an acceptable level of consumption, while high consumption operating range 82 may be colored yellow to indicate that consumption is high, while operating range 84 may be colored red to indicate that consumption is unacceptably high and the building manager may want to take actions to reduce electrical usage. In one embodiment, the operating ranges 80, 82, 84 may change on a periodic basis to reflect expected operations based on historical operating data 58 and weather prediction data 56 for example. In another embodiment, the operating ranges may be operator definable.

The first gauge 74 further includes a digital readout 86 that displays the current power demand in kilowatts (KW). A second digital readout 88 displays consumption measured in KW hrs, the readout 88 may be reset by the operator to display real time KW hrs consumed on an annual, monthly, weekly, or 24 hour basis. In one embodiment, the property management console 28 is configured with alarm notifications, including but not limited to audible, visual, email, instant message and text message for example, for notifying the building manager when consumption or demand levels on first gauge 74 are approaching or projected to approach an undesired operating range. In another embodiment, emails are also sent to next tier property managers.

The second gauge 76 is an indicator of real time or nearly real-time fuel (steam, oil, natural gas) demand and consumption. In the exemplary embodiment, the second gauge 76 indicates the consumption of thermal energy, such as steam from a district heating system for example. The second gauge 76 includes a representation of an analog needle indicator 90 that points to the current steam demand as measured in thousands of pounds per hour (mlbs). Similar to the first gauge 74, the second gauge 76 includes operating ranges 92, 94 that provide a visual cue to the operating state of steam consumption.

The second gauge 76 includes a first digital readout 96 indicating the current steam demand in incremental units appropriate for the historical demand of the heating plant (thousands or hundreds of pounds per hr). A second digital readout 98 provides an indication of consumption, in units appropriate for the heating plant history that will display consumption on an annual, monthly, weekly, or daily basis. In one embodiment, the property management console 28 is configured with alarm notifications, including but not limited to audible, visual, email, instant message and text message for example, for notifying the building manager when consumption or demand levels on second gauge 76 are approaching or projected to approach an undesired operating range, such as operating range 94 for example. In another embodiment, emails are also sent to next tier property managers.

In the embodiment of FIG. 3, the indicator portion 72 includes a plurality discrete indicators each associated with one of the subsystem inputs 24. These include a FACS indicator 100, BMS indicator 102, EMIS indicator 104, EMS indicator 106, ACS indicator 108 and SCADA indicator 110. Each indicator includes an adjacent label portion providing a description of the indicator. The indicator portion 72 may also include additional indicators, such as an UGS indicator (not shown), as desired by the building manager. In the exemplary embodiment, the indicators may be color coded to provide the building manager with a snapshot of the operational status of the building 22 without having to focus on the indicator portion 72. In one embodiment, the indicators are green when a subsystem is operating normally, yellow when a parameter is within operating parameters but outside the expected range, and red when a parameter is outside the desired operating range.

In the exemplary embodiment, the gauge and indicator portions 71, 72 are selectable or clickable by the building manager using a user interface, such as a mouse, when the building manager desires more information. In one embodiment, by selecting a part of the gauge and indicator portions 71, 72, the property management console 28 allows the building manager to drill down into the data underlying the selected gauge or indicator. In one embodiment, the selection of the gauge or indicator executes the usage reports 62 that are appropriate for the selection.

A version of the display 30 could be made available to tenants on the tenant management console 70 by transmitting the same, but filtered, real time and historical data to the end users office computer. The information would be formatted in metrics relevant to the tenant or end user. For example, instead of readout of kilowatts per hour, the gauge could read dollars/cents per hour and would provide advantages in incentivizing load reduction and energy conservation.

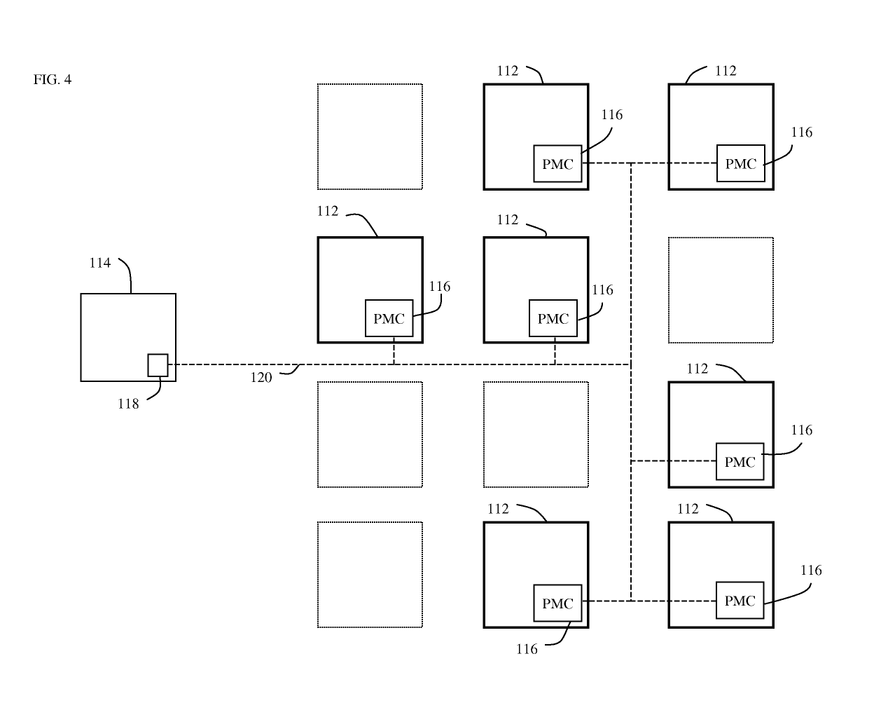

The exemplary embodiment described the property management system 20 with respect to a single building 22. Turning now to FIG. 4, an embodiment having multiple buildings 112 or multiple properties will be described. It is not uncommon for a building owner or a building manager to be in one location 114 and be responsible for several, sometimes geographically distant, buildings or properties.

Each of the individual buildings 112 has a property management console 116 that is substantially similar property management console 28 described herein above. Each of the building property management consoles 116 are coupled to a master property management console 118 by a communications medium 120. The communications medium 120 may be any known communication medium, including but not limited to a wide area network (WAN), a public switched telephone network (PSTN) a local area network (LAN), a global network (e.g. Internet), a virtual private network (VPN), and an intranet. The communications network 120 may be implemented using a wireless network or any kind of physical network implementation known in the art. The individual building property management consoles 116 may be coupled to the property management console 118 through multiple networks (e.g., intranet and Internet) so that not all individual building property management consoles 116 are coupled through the same network. Furthermore, the individual building property management consoles 116 may be connected to the property management console 118 by a combination of a PSTN and the Internet, for example. One or more of the individual building property management consoles 116 may be connected to the communication medium 120 in a wireless fashion.

In the exemplary embodiment, the property management console 118 includes a display substantially similar to display 30 described herein above. The gauges for property management console 118 could display either total amounts from all of the buildings 112, or data for individual buildings 112. In this manner, the property manager may track the total consumption of all the buildings they manage, which may provide advantages monitoring compliance with long term service contracts that property manager executes with energy suppliers.

An embodiment of the invention may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, USB (universal serial bus) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to manage energy consumption and monitor operational status of subsystems within a building.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A property management system comprising:
a plurality of building subsystems, each of the plurality of building subsystems having an associated control;
at least one database, the at least one database having historical data for a building;
a display; and,
a controller operably coupled to the plurality of building subsystems, the at least one database and the display, the controller having a processor responsive to executable computer instructions when executed on the processor for displaying a first graphical representation on the display indicating a consumption level of energy of at least one of the plurality of building subsystems.

2. The property management system of claim 1 wherein the processor is further responsive to executable computer instructions when executed on the processor for displaying a second graphical representation on the display indicating a status of one of the plurality of building subsystems.

3. The property management system of claim 2 wherein the first graphical representation includes a first indicator that points to the consumption level of energy on a first operating range.

4. The property management system of claim 3 wherein the first operating range includes a second operating range, a third operating range and a fourth operating range.

5. The property management system of claim 4 wherein the processor is further responsive to executable computer instructions when executed on the processor for displaying a third graphical representation on the display indicating a consumption level of thermal energy of at least one of the plurality of building subsystems.

6. The property management system of claim 5 wherein the third graphical representation further includes a second indicator that points to the consumption level of thermal energy on a fifth operating range.

7. The property management system of claim 6 wherein the consumption level of thermal energy is a consumption level of steam.

8. The property management system of claim 7 wherein the plurality of building subsystems includes at least one of a fire alarm and communications system, a building management system, and elevator management and information system, an access control system, a supervisory control and data acquisition system, an energy management system and a visitor management system.

9. A property management system comprising:
a master property management controller including an input for receiving a first signal from a plurality of first property management controllers, each of the first property management controllers associated with one of a plurality of buildings;
a display coupled to the master property management controller;
wherein the master property management controller includes a processor responsive to executable computer instructions when executed on the processor for displaying a first graphical representation on the display indicating an aggregate consumption level of energy for the plurality of buildings in response to the first signal.

10. The property management system of claim 9 wherein:
each of the plurality of buildings has a plurality of subsystems; and,
the processor is further responsive to executable computer instructions when executed on the processor for displaying a second graphical representation on the display indicating an aggregate status of at least one of the plurality of subsystems in response to the first signal.

11. The property management system of claim 10 wherein the processor is further responsive to executable instructions when executed on the processor for changing a color of the aggregate status in response to a second signal from one of the plurality of first property management controllers.

12. The property management system of claim 11 wherein the second graphical representation further includes a utility grid status indicator.

13. The property management system of claim 12 wherein the first graphical representation includes a first indicator that points to the aggregate consumption level of energy on a first operating range, the first operating range including a second range, a third range and a fourth range.

14. The property management system of claim 13 wherein the processor is further responsive to executable computer instructions for changing levels of the second range, the third range and the fourth range in response to a third signal.

15. The property management system of claim 14 wherein the second signal includes historical operating data and weather prediction data.

16. The property management system of claim 14 wherein the third signal is an operator defined operating range.

17. A method of pre-starting a building heating, ventilation and air conditioning system comprising:
storing a first building performance data in a database, the first building performance data including weather data, pre-start initiation time, and pre-start finish time;
receiving a weather forecast data;
correlating the first building performance data with the weather forecast data; and,
determining a time for the pre-start initiation time of the building heating, ventilation and air conditioning system from the correlated first building performance data to achieve a first operating temperature.

18. The method of claim 17 further comprising initiating the building heating, ventilation and air conditioning system at the time.

19. The method of claim 18 further comprising:
measuring a second building performance data after the time, the second building performance data including a second operating temperature; and,
storing the second building performance data.

20. The method of claim 19 further comprising comparing the first operating temperature to the second operating temperature.
